(19) United States
(12) Patent Application Publication
(10) Pub. No.: US 2016/0161406 A1
(43) Pub. Date: Jun. 9, 2016

(54) CARTRIDGE FOR ANALYZING SPECIMEN BY MEANS OF LOCAL SURFACE PLASMON RESONANCE AND METHOD USING SAME

(71) Applicant: PLEXENSE, INC., Yuseong-gu, Daejeon (KR)

(72) Inventor: Gibum Kim, Sacramento, CA (US)

(21) Appl. No.: 14/773,304

(22) PCT Filed: Mar. 5, 2014
(86) PCT No.: PCT/KR2014/001799

§ 371 Date: Feb. 4, 2016

(30) Foreign Application Priority Data
Mar. 5, 2013 (KR) 10-2013-0023326

(51) Int. Cl. G01N 21/552; G01N 21/59

(52) U.S. Cl. CPC G01N 21/554; G01N 21/59; G01N 2021/5903

(57) ABSTRACT

Present invention describes a cartridge for analyzing target analytes in biological compound, low molecular weight compound, or other samples and an analysis method using the cartridge. In more detail, the present invention describes a fabrication method of a cartridge to measure, based on localized surface plasmon resonance (LSPR) phenomenon, changes in absorbance values or maximum absorption wavelength values, which are caused by changes in effective refractive index due to the reactivity difference between biological compounds or low molecular weight compounds on the metal nanoparticle immobilized surface, and a sample analysis method.

### TECHNOLOGICAL FIELD

Present invention describes a cartridge for analyzing target analytes in biological compound, low molecular weight compound, or other samples and an analysis method using the cartridge. In more detail, the present invention describes a fabrication method of a cartridge to measure, based on localized surface plasmon resonance (LSPR) phenomenon, changes in absorbance values or maximum absorption wavelength values, which are caused by changes in effective refractive index due to the reactivity difference between biological compounds or low molecular weight compounds on the metal nanoparticle immobilized surface, and a sample analysis method.

### BACKGROUND TECHNOLOGY

A localized surface plasmon resonance (LSPR) based analysis method is a method which measures a sample concentration-dependent refractive index change by forming a metal nanoparticle thin film layer on a transparent substrate surface followed by measuring an intensity change or a wavelength change of light emitted from the light source upon being reflected on or transmitted to the metal thin film layer. Recently significant research has been devoted to analysis methods for analyzing biological and non-biological samples by using a plasmon resonance phenomenon based analysis method.

Traditionally, a largely two-step method has been employed for analyzing biological samples such as nucleic acids and proteins. The first step is to measure the concentration (level) of target analytes by measuring optical absorbance using a UV-visible spectroscopic method. This absorbance is measured by comparing light intensities before and after passing a constant intensity light through the sample. Since this optical absorbance measurement method measures only the concentration of specific functional groups, an additional method should be applied to the quantitative analysis of reactivity and activity of specifically binding target analytes in biological reactions.

A quantitative analysis of reactivity and activity of specific target analytes has been traditionally performed by using an enzyme-linked immunosorbent assay (ELISA) which is a quantitative analysis method for detecting a target antibody after chemical bonding of an enzyme such as peroxidase or galactosidase onto the antibody in a specific antigen-antibody reaction. Additionally, an immunofluorescence assay has been employed for analyzing target analytes, which uses a fluorescence microscope and labeling of fluorescence dye such as fluorescein or Rhodamine to antibody or antigen.

Although the above mentioned methods have been widely used due to their high sensitivity in analyzing reactivity and activity upon binding of a target analyte in the sample to a receptor molecule, they require a longer time and/or high cost due to highly complex sample preparation steps, sample or target labeling, and/or expensive instruments. Especially, an immunoassay or immunofluorescence assay needs to use different antibodies depending on target analytes and requires long time for analysis and thus it has difficulty in fast screening of large amount of libraries during the processes of drug and biomarker discovery.

### DETAILED DESCRIPTION OF THE INVENTION

### Technical Problems

Accordingly, the present invention offers a simplified and low-cost analytical method, without additional sample pretreatment steps, for measuring reaction between biological samples or between biological and non-biological samples, such as measuring reactivity or activity between low molecular weight compounds. Especially, the present invention aims to provide a new highly sensitive analytical method to simultaneously measure both concentration and reaction kinetics upon reaction between a biological sample, such as a nucleic acid, and a protein or low molecular weight compound which reacts with the sample.

### Solutions for the Technical Problems

In order to achieve the above stated aim, the present invention uses a cartridge which utilizes localized surface plasmon resonance(LSPR). The cartridge comprises a sample inlet into which the target analyte or receptor molecule sample being analyzed is introduced, a sample flow channel which connects the sample inlet to the measurement window region to introduce the target analyte or receptor molecule sample into the measurement window region, and a measurement window in which LSPR-active species is immobilized onto a substrate to form a thin film layer on which a target analyte is attached. Ideally, the above stated cartridge is a cuvette holding device which is installed on the sample holder part of the transmittance measurement instrument measuring transmittance of visible light.

In addition, the present invention offers a LSPR-based target analysis method comprising; a procedure of introducing the target analyte sample into the sample inlet of the cartridge; a procedure of measuring wavelength-dependent changes in absorbance or maximum absorption wavelength for the target analyte immobilized on the measurement window of the cartridge; a procedure of introducing a receptor molecule sample which binds to the target analyte sample; a procedure of measuring wavelength-dependent changes in absorbance or maximum absorption wavelength for the receptor molecule which reacted with the target analyte on the measurement window of the cartridge; a procedure of calculating wavelength-dependent changes in absorbance or maximum absorption wavelength for the stated receptor molecule and target analyte samples; and a procedure of analyzing reactivity between the target analyte and receptor molecule samples using the absorbance change values or maximum absorption wavelength change values measured in the previous procedure.

The present invention based on the LSPR phenomenon does not require complex labeling procedures, unlike the conventional enzyme immunoassays requiring complex procedures for labeling of the sample molecules with fluorophore. Thus, the present invention allows a simple, low-cost, label-free quantitative analysis of the samples. It can be applied to the conventional spectrophotometers, without purchasing additional detection equipment. Consequently, the present invention has been realized by focusing on the fact that a relatively simple, low-cost quantitative analysis is possible using relatively simple equipment as compared with the conventional SPR analysis methods.

The LSPR-based analysis method in the present invention is a quantitative analysis method measuring the concentration of the target analyte sample using change in absorbance or maximum absorption wavelengths of metal nanoparticles, which depends on local refractive index changes in the close proximity of the nanoparticles upon binding of the receptor molecules with target analytes. The present invention has a merit of offering the customers a low-cost LSPR-based alternative analysis method which employs widely used conventional spectrophotometers, without purchasing dedicated detection equipment, as compared with the conventional LSPR-based analysis methods which uses disposable cartridges and costly dedicated detection equipment.

The present invention allows to measure LSPR phenomenon by providing an additional cartridge which can be attached to the sample holder part of the conventional ultraviolet-visible spectrophotometers to induce the LSPR phenomenon, when performing quantitative analysis of biological samples whose molecular structure or repetitive unit sequence directly affects their reactivity or activity.

As a result, the present invention can be widely used in various sample analyses including drug candidate screening because it allows to measure reactivity or activity of the target analyte in the sample using a conventional spectrophotometer and to simplify reactivity measurement, conventionally performed in multiple steps, without using costly dedicated analysis equipment.

### BRIEF DESCRIPTION OF THE DRAWINGS

FIG. 1 is a perspective view of the cartridge, referring to the first embodiment of the present invention.

FIG. 2 is an exploded view of the cartridge, referring to the first embodiment of the present invention.

FIG. 3 is a black and white optical image of the cartridge used with a spectrophotometer, referring to the first embodiment of the present invention.

FIG. 4 is a perspective view of the cartridge with two measurement windows, referring to another embodiment of the present invention.

FIG. 5 shows graphs of an absorbance change over a range of wavelength in absorption spectra of samples measured by using the cartridge, referring to the first embodiment of the present invention.

FIG. 6 is a graph of absorbance value changes at a specific wavelength upon increasing an effective refractive index, referring to the first embodiment of the present invention.

FIGS. 7a and 7b are graphs showing selective binding of anti-BSA with samples in a cartridge, referring to the first embodiment of the present invention.

### PREFERRED EMBODIMENTS OF THE INVENTION

Present invention is best described as follows:

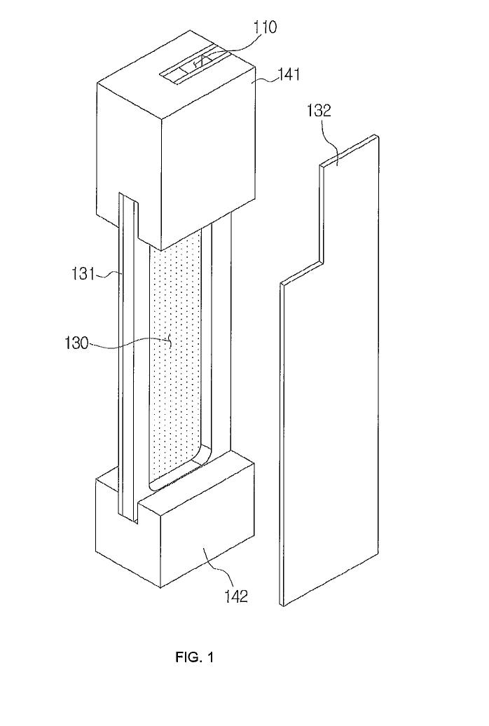

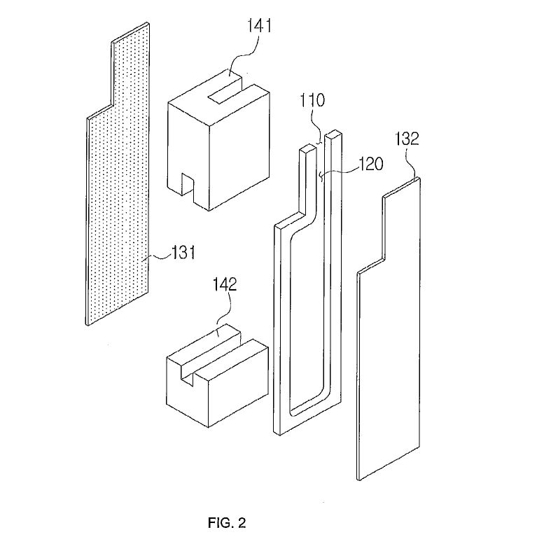

FIG. 1 is a perspective view of the cartridge referring to the first embodiment of the present invention and FIG. 2 is an exploded view of the cartridge referring to the first embodiment of the present invention.

Referring to FIGS. 1 and 2, the cartridge referring to the first embodiment of the present invention utilizes a LSPR-phenomenon and can comprise a sample injection part(110) for introducing a target analyte sample or a receptor molecule sample into; a sample channel part(120) connecting the sample injection part and a measurement part for feeding the target analyte sample or the receptor molecule sample into the measurement part; and a measurement part(130) comprising target analysis materials immobilized on a thin film layer of localized surface plasmon resonance(LSPR)-active materials immobilized on a substrate(131). The above stated cartridge is installed into the sample cuvette holder of a transmittance or absorbance measurement device, the above stated transmittance or absorbance measurement device can be a device capable of measuring transmittance or absorbance of visible light. In addition, the above stated transmittance or absorbance measurement device can be a device capable of measuring transmittance or absorbance of any one of visible, ultra-violet, and infra-red lights or can be a spectrophotometer.

The above cartridge can measure binding reaction kinetics between the target analyte and receptor molecules. Also, the above cartridge comprises an additional sample outlet part (not drawn) under the measurement part (130) for draining out the sample materials unreacted with the target analyte. The substrate (131) of the measurement part (130) is desirable to have an optically transparent polymeric material selected from the group composed of polyethylene terephthalate (PET), poly(methyl methacylate) (PMMA), polystyrene (PS), polycarbonate (PC), cyclic olefin copolymer (COC) and combinations thereof. The top window (132) of the measurement part (132) can be any material which allows transmittance or absorbance measurement of samples. In addition, the cartridge can be fixed by the top window (141) and the bottom window (142) so as to be installed to the cuvette sample holder of the transmittance or absorbance measurement device.

The stated target analyte sample can be blood, saliva, nose blood, tear, excrement, tissue extract or cell culture medium. More desirably it can be antibody, antigen, protein, DNA, RNA, PNA or combinations thereof. Also, the stated receptor molecule sample can be a low molecular weight compound, antibody, antigen, protein, DNA, RNA, PNA or combinations thereof. But the receptor molecule sample is not limited to them if it can detect the stated target analyte. In addition, the LSPR-active materials of the stated measurement part (130) can be metal nanoparticles and the stated metal nanoparticles can be gold, silver, copper, nickel or combinations thereof.

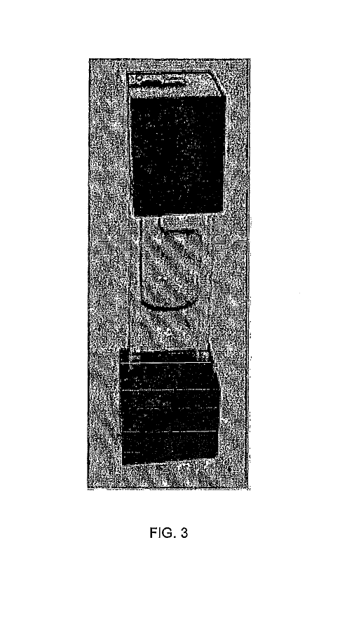

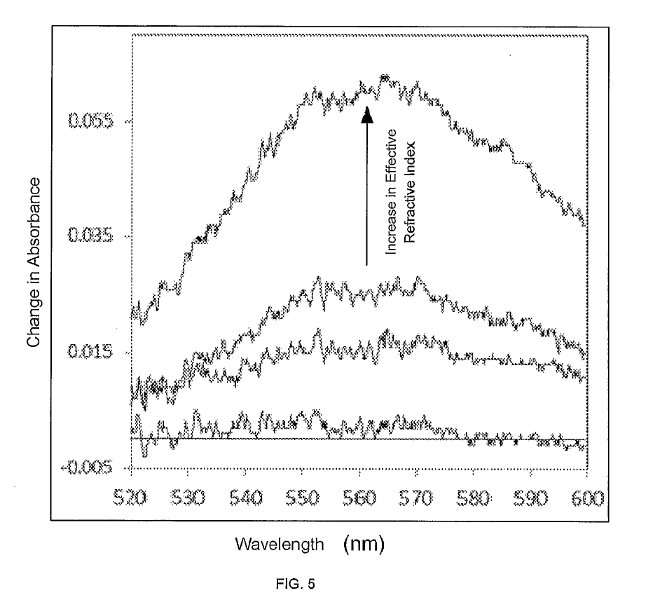

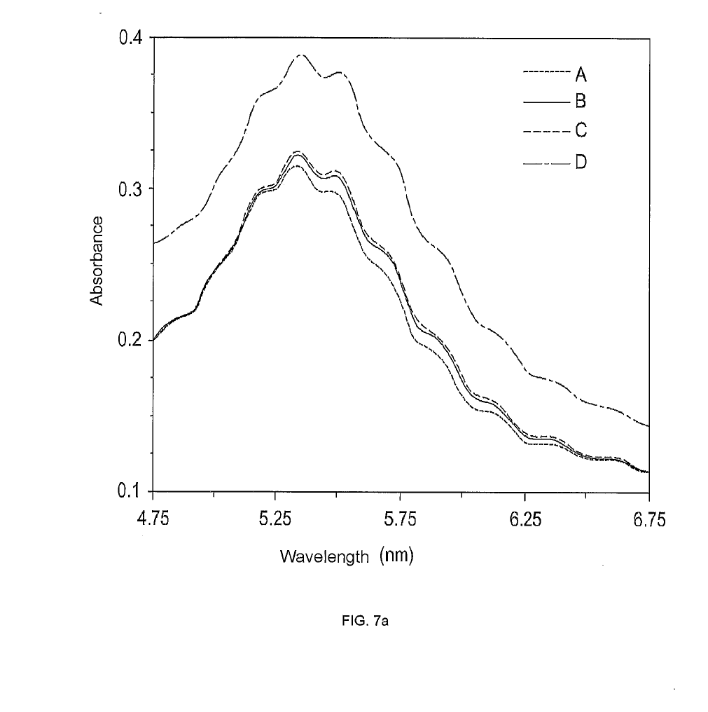

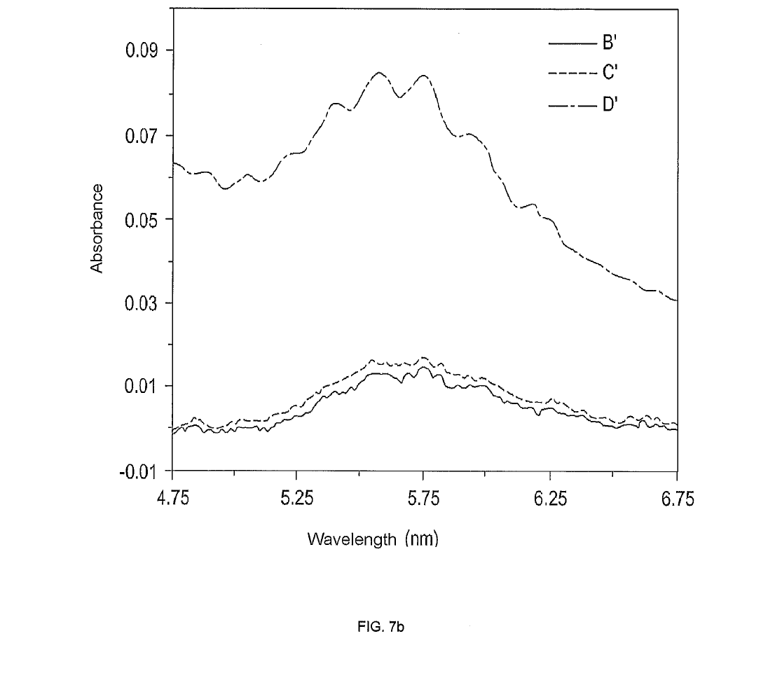

FIG. 3 is a black and white optical image of the cartridge used with a spectrophotometer, referring to the first embodiment of the present invention. Referring to FIG. 3 together with FIG. 1, the gray area in the center of FIG. 3 is the area coated with LSPR-active materials on the substrate (131) of the measurement part (130) and the black areas in the top and bottom are the top holder (141) and bottom holder (142), respectively. The substrate can be visually identified in purple due to the coating of LSPR-active materials on the transparent substrate (131). The sample in the measurement part (130) can be analyzed by using the SPR phenomenon of the metal nanoparticles coated on the substrate (131). The stated analysis method and experimental results of the embodiments referring to the stated method will be described in detail in FIGS. 5 and 7b.

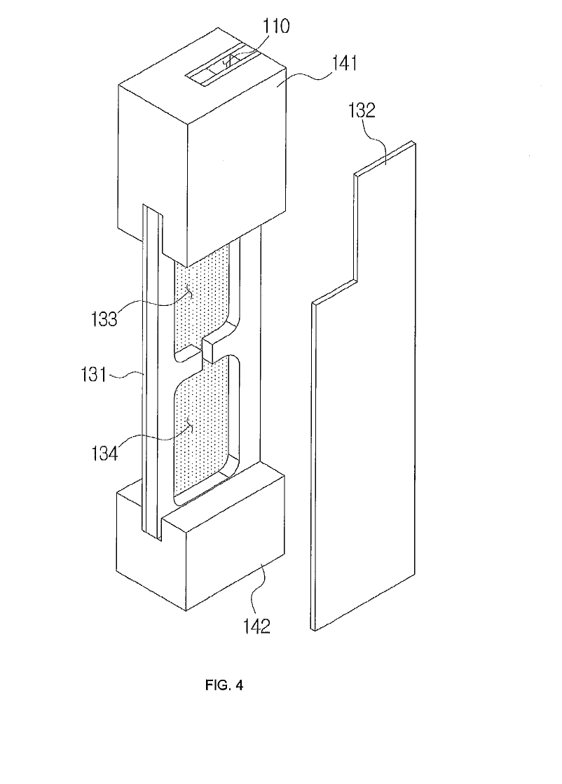

FIG. 4 is a perspective view of the cartridge with two measurement windows, referring to another embodiment of the present invention. Referencing to FIG. 4, the cartridge referring to another embodiment in the present invention can include two separate measurement windows (133, 134) and a sample channel part (not drawn) connecting the sample measurement windows (133, 134) and the sample injection part (110) for introducing the target analyte or receptor molecule sample, previously introduced into the sample injection part (110), into each measurement windows (133, 134). Other components composing the stated cartridge can be consulted with the detailed descriptions referring to FIGS. 1 and 2. In some embodiments, the sample can be selectively introduced through the sample injection part (110) to only one of the two separated measurement windows. For instance, the target analyte sample and the receptor molecule sample can be introduced onto the thin coating layer of the stated 1^{st} measurement window (133) whereas neither the target analyte sample nor the receptor molecule sample is introduced onto the thin coating layer of the stated 2^{nd} measurement window (134). In this case, the 2nd measurement window (134) with no sample allows absorbance measurement without the sample and the measurement can be done simultaneously with absorbance measurement of the 1st measurement window (133) filled with the sample. As a result, quantitative measurement of the target analyte sample becomes possible by comparing the absorbance values of the two separated measurement windows which are without and with the sample, respectively.

In addition, in a different embodiment, the 1^{st} measurement window (133) can be a high contrast part (C_{H}; a positive control) of a thin film layer immobilized with materials whose effective refractive index (R_{H}) is higher than that of the target analyte or receptor molecule and the 2^{nd} measurement window (134) can be a low contrast part (C_{L}; a negative control) of a thin film layer immobilized with materials whose effective refractive index (R_{L}) is lower than that of the target analyte or receptor molecule.

In a quantitative analysis of a target analyte, measurement of an absorbance(A) or a maximum absorption wavelength (λ1) can include a background noise (N) due to the internal or external condition of the sample. Removal of such a background noise is essential for an accurate quantitative analysis of the target analyte. The background noise is equally included in the stated high contrast, low contrast, and sample measurement parts. Methods for noise removal and a quantitative analysis will be described in the following detailed description of methods.

In another embodiment, the 1^{st} measurement window (133) forms a thin film layer of LSPR-active materials immobilized on the substrate and the 2^{nd} measurement window (134) can be only a substrate. The 1st measurement window (133) allows a quantitative analysis of the target analyte because of the immobilization of the target analyte and the 2nd measurement window (134) composed of only the substrate allows absorbance measurement, without using a LSPR phenomenon, of typical samples.

In a method of analyzing a target analyte sample using a localized surface plasmon resonance (LSPR) phenomenon, the present invention provides a sample analysis method comprising:
1) a step introducing the target analyte sample into the sample injection part of the cartridge;
2) a step measuring an absorbance change (A₁) or maximum absorption wavelength (λ₁) of the target analyte affixed onto the measurement part of the stated cartridge upon changing wavelength;
3) a step introducing the receptor molecule sample reacting with the target analyte sample into the sample injection part of the cartridge in step 1;
4) a step measuring an absorbance change (A₂) or maximum absorption wavelength (λ₂) of the receptor molecule reacted with the target analyte on the measurement part of the cartridge upon changing wavelength;
5) a step calculating an absorbance change difference (A₁-A₂) or maximum absorption wavelength difference (λ₁-λ₂), using the measured values in Steps 2) and 4); and
6) a step analyzing reaction kinetics between the target analyte and the receptor molecule using the absorbance change difference or maximum absorption wavelength difference obtained in Step 5).

The stated cartridge can be a cuvette fitted into the sample holder of a visible absorption or transmission spectrophotometer, and absorbance measurement can be achieved by using a device capable of measuring transmittance of visible light.

Desirably the substrate (131) of the stated measurement part can be an optically transparent polymeric material selected from the group consisting of polyethylene terephthalate (PET), poly(methyl methacylate) (PMMA), polystyrene (PS), polycarbonate (PC), cyclic olefin copolymer (COC) and combinations thereof. The stated target analyte sample can be blood, saliva, nose blood, tear, excrement, tissue extract or cell culture medium and more desirably it is antibody, antigen, protein, DNA, RNA, PNA or combinations thereof. Also, the stated receptor molecule sample can be low molecular weight compounds, antibody, antigen, protein, DNA, RNA, PNA or combinations thereof. In addition, the LSPR-active materials of the stated measurement part can be metal nanoparticles and more desirably the stated metal nanoparticles can be gold, silver, copper, nickel or combinations thereof.

In the above described analysis method, Step 1) can comprise an additional step of measuring absorbance of the cartridge before introducing the target analyte sample.

In addition, in another embodiment, any one step between the Steps 1) and 6) includes the cartridge with additional two measurement windows: one measurement window is a high contrast part (C_{H}) of the materials which are immobilized on the thin film layer and whose effective refractive index (R_{H}) is higher than that of the target analyte or the receptor molecule and the other measurement window is a low contrast part (C_{L}) of the materials which are immobilized on the thin film layer and whose effective refractive index (R_{L}) is lower than that of the target analyte or the receptor molecule. Additional steps can be included to measure absorbance (A₃) or maximum absorption wavelength (λ₃) of the high contrast part and absorbance (A₄) or maximum absorption wavelength (λ₄) of the low contrast part and then to calculate a correction factor (CF) which is a ratio of an absorbance difference (A₃-A₄) or maximum absorption wavelength difference (λ₃-λ₄) to an effective refractive index change (R_{H}-R_{L}) calculated using already-known R_{H} and R_{L} values.

As previously described, a background noise(N) can be included in measurement of the absorbance or maximum absorption wavelength of the target analyte sample. To remove the noise, CF values for the high and low contrast parts can be measured after immobilizing a material whose effective refractive index is higher or lower than that of the target analyte or the receptor molecule. A quantitative analysis of the reactivity between the target analyte and the receptor molecule is made through calculation using the measured CF values and the absorbance change (A₂) measured in the stated Step 4.

The concentration of target analyte(C_{S}) on the LSPR-active surface is proportional to its effective refractive index value (N_{S}), and the relationship between the effective refractive index value and the absorbance value (A_{S}) or the maximum absorption wavelength value (_{S}) can be expressed as follows:

C_{S}=aN_{S}

N_{S}=SA_{S} or N_{S}=S_{S}

C_{S}=aSA_{S} or C₂=aS_{S}, which is

C_{S}=S(aA_{S}) or C_{S}=S(a_{S},

where “a” is a slope of the target analyte concentration change over the effective refractive index value change, “S” represents the absorbance value change or the maximum wavelength value change of LSPR phenomenon over the effective refractive index value change. Since “a” is a fixed value determined from the molecular structure and surface density of the target analyte at the given surface environment, the concentration of the target analyte (Cs) can be determined by measuring on the LSPR-active surface the difference in the absorbance values (aAS) or the maximum absorption wavelength values (aS) of the materials with the known effective refractive index values using the high and low contrast parts followed by calculating “S” value. In order to measure relative reactivity or activity between the target analyte and the receptor molecule, the absorbance value or the maximum absorption wavelength is measured, the absorbance value or the maximum absorption wavelength value from the low contrast part is measured, contribution of other materials in the sample to the absorbance value or the maximum absorption wavelength is subtracted, and then differences in the relative reactivity or activity can be compared for several numbers of target analytes.

In order to measure the surface concentration of the target analyte, the target analyte is immobilized on the measurement window with LSPR-active materials and then the absorbance value at a given wavelength or the maximum absorption wavelength is measured, after that the receptor molecule reacting with the target analyte is additionally introduced into the measurement window of the measurement part and then the absorbance value at the given wavelength or the maximum absorption wavelength is measured. The relative reactivity or activity of the receptor molecule toward the target analyte can be determined from the difference in the absorbance values or the maximum absorption wavelength before and after introducing the receptor molecule.

An accurate quantitative analysis requires reducing or removal of the background signal originated from other materials co-existing with target analyte in the sample. Quantitative measurement of reactivity or activity of the target analyte can be achieved by constituting separate high and low contrast parts on the measurement part of the cartridge.

In the cartridge having the measurement part composed of two measurement windows, one measurement window is a high contrast part (C_{H}) of the materials which are immobilized on the thin film layer and whose effective refractive index (R_{H}) is higher than that of the target analyte or the receptor molecule and the other measurement window is a low contrast part (C_{L}) of the materials which are immobilized on the thin film layer and whose effective refractive index (R_{L}) is lower than that of the target analyte or the receptor molecule. Absorbance (A₃) or maximum absorption wavelength (λ₃) of the high contrast part and absorbance (A₄) or maximum absorption wavelength (λ₄) of the low contrast part are measured and then a correction factor (CF) can be calculated as a ratio of an absorbance difference (A₃-A₄) or maximum absorption wavelength difference (λ₃-λ₄) to an effective refractive index change (R_{H}-R_{L}) using already-known effective refractive index value(R_{H}) of the high contrast part and effective refractive index value(R_{L}) of the low contrast part.

$$\begin{matrix}CF = ( {A}_{3} - {A}_{4} ) / ( {R}_{H} - {R}_{L} ) or \\ = ( {λ}_{3} - {λ}_{4} ) / ( {R}_{H} - {R}_{L} )\end{matrix}$$

Measuring the responsivity of LSPR signal from a sample, which is the slope of the LSPR signal intensity over a range of sample concentrations, permits to measure the relative difference of the LSPR signal intensity of the sample, which is the absolute value of the reactivity, and that can be used to remove the background signal. A quantitative analysis of the target analyte can be achieved by generating a calibration curve, which shows the relationship of the effective refractive index values to the absorbance values or to the maximum absorption wavelength values, using CF values followed by determining the effective refractive index value of the target analyte or the receptor molecule against the absorbance value or the maximum absorption wavelength value using the calibration curve. Especially, the reactivity between the target analyte and the receptor molecule can be quantitatively analyzed by providing the concentration of target analyte reacted finally as the difference in absorbance values.

A correction factor, which is a change in an absorbance value or maximum absorption wavelength over a change in an effective refractive index value, can be calculated using the 1^{st} optical signal from the target analyte (absorbance value A₁, the maximum absorption wavelength value λ₁), the 2^{nd} optical signal from the receptor molecule (absorbance value A₂, the maximum absorption wavelength value λ₂), the 3^{rd} optical signal from the high contrast part (absorbance value A₃, the maximum absorption wavelength value λ₃), the 4^{th} optical signal from the low contrast part (absorbance value A₄, the maximum absorption wavelength value λ₄), and the known effective refractive index values of the high contrast part (R_{H}) and low contrast part (R_{L}). The calculated CF value can be used to measure the reactivity or activity of the target analyte.

### Example Embodiments of the Invention

The following describes the present invention in more detail with example embodiments. However, the following example embodiments are exemplary for describing the present invention and thus the scope of the present invention is not limited to the example embodiments.

### EXAMPLES

### 1. Cartridge Fabrication

For analyzing a target analyte in the present invention, a cartridge has been fabricated to be used with a Genesys 10A spectrophotometer manufactured by Thermo-Fisher. Gold nanoparticles were uniformly coated on a 250-micrometer thick polymeric film substrate (PET, PMMA, or polycarbonate) and then the coated substrate was cut into a size which is suitable to place in a cuvette holder of the spectrophotometer. A fluidic channel structure comprising a sample inlet and a fluidic channel was fabricated and placed in-between two cut polymeric film substrates immobilized with gold nanoparticles to introduce the sample. FIG. 3 is a real picture showing the cartridge fabricated. In the example embodiment a cartridge was used with a spectrophotometer, but the cartridge can be used, without any limitation, with any devices measuring absorbance or transmittance of visible light.

2. Absorbance Measurement over the Effective Refractive Index Value

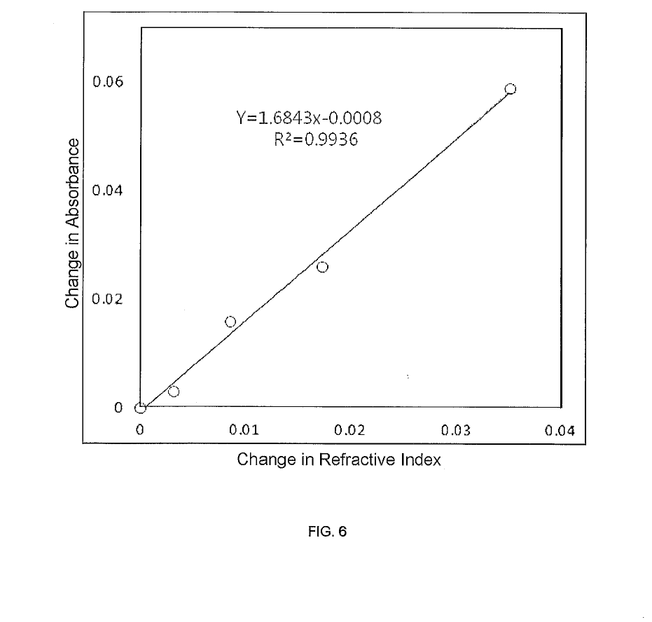

Absorbance values were measured upon increasing sodium chloride concentration of its aqueous solution so as to increase the refractive index value of the solution from 1.3333 to 1.3795 and the measurement results are shown in FIG. 5. FIG. 5 shows graphs obtained by subtracting the absorbance spectrum of distilled water (refractive index=1.3333) from the absorption spectra of the aqueous sodium chloride solutions to display only an absorbance value changes over the wavelength range of the absorption spectra. As described previously, the absorbance value increases with increasing the effective refractive index value due to the activation of LSPR phenomenon on the thin layer of metal nanoparticles. Plotting an increase in the absorbance value at 560 nm with increasing an effective refractive index in FIG. 5 leads to FIG. 6. FIG. 6 confirms that absorbance value of the metal nanoparticle thin layer of the cartridge fabricated referring to the embodiment increases linearly with increasing the effective refractive index value of the sample; and that shows a linear response of the LSPR phenomenon of the stated cartridge against the change in effective refractive index values of the sample. Therefore, the cartridge fabricated referring to the embodiment of the present invention can be used to measure the LSPR phenomenon with using a conventional spectrophotometer, without using a costly dedicated detection instrument.

### 3. Measuring Selective Binding of Anti-BSA by Using BSA

FIGS. 7a and 7b are graphs showing the results for the selective reactivity of the sample measured using absorbance. In order to measure selective reactivity of the sample, bovine serum albumin (BSA) is prepared as a target analyte, anti-BSA antibody is prepared as a receptor molecule, and streptavidin (SA) is prepared as a non-target analyte (negative control).

After inserting the stated cartridge to the spectrophotometer (Genesys 10A Spectrophotometer, Thermo-Fisher) but before introducing target analyte sample, an absorbance of the measurement part filled with 0.1M PBS (phosphate buffered saline, Sample A) was measured to confirm its spectrum, and the results are shown as the curve A in FIG. 7a. Then, an absorbance of the cartridge filled with a 0.1 mg/ml sample (anti-BSA antibody, Sample B) was measured and the results are shown as the curve B in FIG. 7a. After that, an absorbance of the cartridge filled with replaced 50 ul of 0.1 mg/ml SA (Sample C) was measured and the results are shown as the curve C in FIG. 7a. In addition, an absorbance of the cartridge filled with replaced 50 ul of the target analyte (0.1 mg/ml BSA, Sample D), instead of 50 ul of 0.1 mg/ml SA, was measured and the results are shown as the curve D in FIG. 7a.

It is expected that the absorbance value increases more upon the introduction of BSA as compared with the introduction of SA because Sample B is a sample recognizing BSA selectively and FIG. 7a confirms that. Referring to FIG. 7a, it has been confirmed that the absorbance values in the curve D for Sample D obtained upon the introduction of BSA are much larger than those in the curve C for Sample C obtained upon introduction of SA.

To clearly show the increase in the absorbance values upon the selective detection of the target sample, FIG. 7b plots graphs obtained by subtracting the curve A, which is the absorption spectrum measured after filling PBS, from the curves B, C, and D, which are absorption spectra measured after introducing the receptor molecule, target analyte and non-target analyte samples, as the curves B′, C′, and D′, respectively.

Referring to FIG. 7b, the increase in the absorbance value becomes shown clearer upon the selective detection of the target analyte. As shown in curve B′, it is confirmed that the measured absorbance value (anti-BSA only) after immobilizing target analyte (anti-BSA) on the cartridge increases by 0.01 at 575 nm region as compared with that for PBS. As shown in curve C′, it is confirmed that the measured absorbance value after introducing non-target 0.1 mg/ml SA on the cartridge immobilized with anti-BSA (anti-BSA/SA) increases by 0.001 at 575 nm region as compared with that for PBS. As shown in curve D′, it is confirmed that the measured absorbance value after introducing target 0.1 mg/ml BSA on the cartridge immobilized with anti-BSA (anti-BSA/BSA) increases by 0.07 at 575 nm region as compared with that for PBS. Thus, the selective reactivity of the target analyte appears to be 70 times increased, in terms of absorbance value, as compared with that of the non-target analyte.

As stated above, it is confirmed that the cartridge in the present invention can be employed for a quantitative analysis of the reactivity between the target analyte and receptor molecule by using the absorbance value changes or the maximum absorption wavelength value changes.

As described previously, although the present invention has been described with limited example embodiments and FIGs, the present invention is not limited only to the stated embodiments and people with common knowledge in the field where the present invention belongs can make various corrections and modifications of the descriptions. Therefore, the present invention should to be examined only within the claims described in the following disclosure, and equal or equivalent modification of the claims is thought to be included in the claims of the present invention.

What is claimed is:

1. A cartridge utilizing a localized surface plasmon resonance phenomenon, the cartridge for analyzing samples comprising:
a sample injection part for introducing a target analyte sample or a receptor molecule sample into;
a sample channel connecting the sample injection part and a measurement part for feeding the target analyte sample or the receptor molecule sample into the measurement part; and
a measurement part comprising target analysis materials immobilized on a thin film layer of surface plasmon resonance(SPR)-active materials immobilized on a substrate.

2. The cartridge of claim 1, wherein the cartridge is installed into the sample cuvette holder of a transmittance measurement device.

3. The cartridge of claim 2, wherein the transmittance measurement device measures transmittance of visible light.

4. The cartridge of claim 1, wherein the stated analysis analyzes reactivity between the target analyte and the receptor molecule.

5. The cartridge of claim 1, wherein the cartridge is connected with the measurement part and comprises additionally a sample outlet part for draining out sample materials unreacted with the stated target analyte.

6. The cartridge of claim 1, wherein the substrate of the measurement part comprises an optically transparent polymeric material selected from the group composed of polyethylene terephthalate (PET), poly(methyl methacylate) (PMMA), polystyrene (PS), polycarbonate (PC), and cyclic olefin copolymer (COC) and combinations thereof.

7. The cartridge of claim 1, wherein the stated target analyte sample comprises blood, saliva, noseblood, tear, excrement, tissue extract or cell culture medium.

8. The cartridge of claim 1, wherein the stated target sample comprises antibody, antigen, protein, DNA, RNA, PNA and combinations thereof.

9. The cartridge of claim 1, wherein the stated receptor molecule sample comprises low molecular weight compounds, antibody, antigen, protein, DNA, RNA, PNA and combinations thereof.

10. The cartridge of claim 1, wherein the LSPR-active materials of the stated measurement part comprise metal nanoparticles.

11. The cartridge of claim 10, wherein metal nanoparticles comprise gold, silver, copper, nickel and combinations thereof.

12. The cartridge of claim 1, wherein the stated measurement part comprises two separated measurement windows, the 1^{st} measurement window and the 2^{nd} measurement window.

13. The cartridge of claim 12, wherein the target analyte sample and the receptor molecule sample are introduced onto the thin film layer of the stated 1^{st} measurement window whereas neither the target analyte sample nor the receptor molecule sample is introduced onto the thin film layer of the stated 2^{nd} measurement window.

14. The cartridge of claim 12, wherein the stated 1^{st} measurement window is a high contrast part (C_{H}) of a thin film layer immobilized with materials whose effective refractive index (R_{H}) is higher than that of the target analyte or the receptor molecule and the stated 2^{nd} measurement window is a low contrast part (C_{L}) of a thin film layer immobilized with materials whose effective refractive index (R_{L}) is lower than that of the target analyte or the receptor molecule.

15. The cartridge of claim 12, wherein the stated 1^{st} measurement window comprises a substrate with a thin film layer of LSPR-active materials and the stated 2^{nd} measurement window comprises only a substrate.

16. A method of analyzing a target analyte utilizing a localized surface plasmon resonance (LSPR) phenomenon, the method comprising:
1) a step introducing the target analyte sample into the sample injection part of the cartridge of claim 1;
2) a step measuring an absorbance change (A₁) or maximum absorption wavelength (λ₁) of the target analyte affixed onto the measurement part of the stated cartridge upon changing wavelength;
3) a step introducing the receptor molecule sample reacting with the target analyte sample into the sample injection part of the cartridge in Step 1);
4) a step measuring an absorbance change (A₂) or maximum absorption wavelength (λ₂) of the receptor molecule sample reacted with the target analyte sample on the measurement part of the cartridge upon changing wavelength;
5) a step calculating an absorbance change difference (A₁-A₂) or maximum absorption wavelength difference (λ₁-λ₂), using the measured values in Steps 2) and 4); and
6) a step analyzing reactivity between the target analyte sample and the receptor molecule sample using the absorbance change difference or maximum absorption wavelength difference obtained in Step 5).

17. The method of claim 16, wherein the cartridge fits into the sample cuvette holder of the equipment used for measuring transmittance of visible light.

18. The method of claim 16, wherein the absorbance measurement utilizes the equipment capable of measuring transmittance of visible light.

19. The method of claim 16, wherein the substrate of the stated measurement part is an optically transparent polymeric material selected from the group consisting of polyethylene terephthalate (PET), poly(methyl methacylate) (PMMA), polystyrene (PS), polycarbonate (PC), cyclic olefin copolymer (COC) and combinations thereof.

20. The method of claim 16, wherein the stated target analyte sample comprises blood, saliva, noseblood, tear, excrement, tissue extract or cell culture medium.

21. The method of claim 16, wherein the stated target analyte sample comprises antibody, antigen, protein, DNA, RNA, PNA and combinations thereof.

22. The method of claim 16, wherein the stated receptor molecule sample comprises low molecular weight compounds, antibody, antigen, protein, DNA, RNA, PNA and combinations thereof.

23. The method of claim 16, wherein the LSPR-active materials of the stated measurement part comprise metal nanoparticles.

24. The method of claim 23, wherein metal nanoparticles are gold, silver, copper, nickel and combinations thereof.

25. The method of claim 16, wherein Step 1) comprises an additional step of measuring absorbance of the cartridge before introducing the target analyte sample.

26. The method of claim 16, wherein in any one step between the Steps 1) and 6) the method comprises the cartridge with two measurement windows comprising additional measurement windows of the 1^{st} measurement window and the 2^{nd} measurement window; the stated 1^{st} measurement window is a high contrast part (C_{H}) of the materials which are immobilized on the thin film layer and whose effective refractive index (R_{H}) is higher than that of the target analyte or the receptor molecule, the stated 2^{nd} measurement window is a low contrast part (C_{L}) of the materials which are immobilized on the thin film layer and whose effective refractive index (R_{L}) is lower than that of the target analyte or the receptor molecule; an absorbance (A₃) or maximum absorption wavelength (λ₃) of the high contrast part and an absorbance (A₄) or maximum absorption wavelength (λ₄) of the low contrast part are measured; a correction factor (CF) is measured as a ratio of an absorbance difference (A₃-A₄) or maximum absorption wavelength difference (λ₃-λ₄) to an effective refractive index change (R_{H}-R_{L}) calculated using already-known R_{H} and R_{L} values.

27. The method of claim 26, wherein a quantitative analysis of reactivity between the target analyte and the receptor molecule is made through calculation using the measured correction factor (CF) value and the absorbance change (A₂) measured in the stated Step 4.
